(19) United States
(12) Patent Application Publication
(10) Pub. No.: US 2018/0131859 A1
(43) Pub. Date: May 10, 2018

(54) Thin Film Camera

(71) Applicants: Shafagh Bayat, Seal Beach, CA (US); Jeffrey Potter, Seal Beach, CA (US)

(72) Inventors: Shafagh Bayat, Seal Beach, CA (US); Jeffrey Potter, Seal Beach, CA (US)

(21) Appl. No.: 15/810,002

(22) Filed: Nov. 10, 2017

Related U.S. Application Data
(60) Provisional application No. 62/420,408, filed on Nov. 10, 2016.

(51) Int. Cl. H04N 5/232

(52) U.S. Cl. CPC H04N 5/23206

(57) ABSTRACT

The present disclosure is directed to systems and methods for a thin film camera device. A thin film camera device includes a flexible base; a capturing component comprising circuitry used to take images or video; an on-board storage memory; at least one port; and a wireless connectivity component comprising circuitry for configuring a wireless connection with at least one external device.

### CROSS REFERENCE TO RELATED APPLICATIONS

This application claims the benefit of U.S. Provisional Application Ser. No. 62/420,408, entitled “THIN FILM CAMERA” and filed on Nov. 10, 2016, the entirety of which is herein incorporated by reference.

### TECHNICAL FIELD

The present disclosure generally relates to thin film cameras or cameras that can be manufactured as thin film devices.

### BACKGROUND

Cameras currently are implemented in cell phones or smart devices but may be inconvenient to carry around. Cameras in phones or other similar devices, as well as standalone cameras, easily break or fracture when dropped onto the ground and can be damaged by a wide variety of other factors. Therefore, there is the problem of convenience, size and sturdiness for camera manufacturing. Furthermore, there needs to be a way to manufacture cameras that are small yet cannot be damaged. There is also a need to we also need to capture image and video from angles and perspectives that are difficult or impossible to achieve from present normal sized cameras due to restrictions in bending and covering and being able to fit present normal sized cameras in certain areas and corners.

### SUMMARY

Provided is a thin film camera device that includes a flexible base; a capturing component comprising circuitry used to take images or video; an on-board storage memory; at least one port; and a wireless connectivity component comprising circuitry for configuring a wireless connection with at least one external device.

Provided also is a method including the steps of: placing the thin film camera device in an area normal cameras cannot reach; triggering the thin film camera device to take a picture or video; storing the recorded picture or video; and retrieving the recorded picture or video.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 shows front and side views of a thin film camera device, according to an aspect of the present disclosure.

FIG. 2A shows a front and rear view of a thin film camera device, according to an aspect of the present disclosure.

FIG. 2B shows two rear views of a thin film camera device, according to an aspect of the present disclosure.

FIG. 3 shows a side straight view and a side bent view of a thin film camera device, according to an aspect of the present disclosure.

FIG. 4 shows a front straight view and a front bent view of a thin film camera device, according to an aspect of the present disclosure.

FIG. 5 shows a side curled view and a titled side view of a thin film camera device, according to an aspect of the present disclosure.

FIG. 6 shows a process flowchart using a thin film camera device, according to an aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts. As described herein, the use of the term “and/or” is intended to represent an “inclusive OR”, and the use of the term “or” is intended to represent an “exclusive OR”.

Provided is a device that is a camera manufactured in thin film that can be flexible and portable, or a thin film camera device or thin camera device. The thin film camera device includes a flexible camera base or flexible base that can have an accent color, a capturing component including circuitry (and can capture images/video using lens or non-lens based technology), and at least one port. The disclosed thin film camera device also may have light absorbing and solar power capabilities on the front, and also wireless and wired port(s) for charging and various data transfer capabilities.

The camera also includes adhesive technology that allows the camera to stick to and re-stick to any complex or simple/practical surfaces (e.g. flat, bumpy, uneven surfaces in nature such as trees, rocks, dirt/sand, walls in houses, tables/desks and so on) for long durations without losing adhesive tolerance. The disclosed thin film camera device may also be physically mounted using any tool to pierce and pin the camera on or around the surface of the disclosed thin film camera device safely far from the image capture/lens technology or any circuitry is included.

A process for method for using the thin film camera device includes: peeling away a film on a layer of a flexible base of the thin film camera device to reveal an adhesive layer; adhering the thin film camera device on a surface via the adhesive layer; and taking a picture with the thin film camera device.

According to an aspect of the present disclosure, the disclosed thin film camera device includes adhesive “repetitive stick” technology in that the thin camera device may be stuck on other surfaces with adhesion or similar means multiple times.

According to an aspect of the present disclosure, the disclosed thin camera device includes a capturing component (which has circuitry and lens or non-lens technology) or a camera capable of capturing perspectives and content from areas and angles beyond the areas and angles that are conventionally limited to normal camera device size and design.

According to an aspect of the present disclosure, the disclosed thin film camera device not only includes an adhesive but also may be mountable by forming a mounting hole that pierces through the thin camera device and mounts the thin camera device onto another surface (e.g. wall, table, desk) as long as the mounting hole does not penetrate important functions of the camera (e.g., circuits, lenses, non-lens components, etc.). A mounting apparatus such as a screw, clamp, pivot, arm, or other device can then connect through the mounting hole and secure the thin camera device to a surface.

According to an aspect of the present disclosure, the disclosed thin film camera device can take pictures by tapping a button on the camera that is on-board or on the actual thin film camera device. Furthermore, the disclosed thin camera can take photographs or record video by tapping a button not on the camera, such as via a remote or via an app on a smartphone, or via a software program on a computer, where all those approaches have some type of wireless or other type of network connection (e.g. Bluetooth, WiFi) with the disclosed thin camera device.

According to an aspect of the present disclosure, video can also be taken by the disclosed thin film camera device by holding a button, such as, e.g. a flat paper-thin button or on-board button that may be touch-sensitive. For example, the disclosed thin film camera can have on board memory and solid state data housing capabilities, or on-board storage memory, or also employ the latest industry standard for local data storage in addition to wireless and port file transfer to third party storage devices (e.g. external hard drives, flash drives, thumb drives, external smart phones, smart tablets, computers, and other similar devices). Again, the disclosed thin film camera is not only be limited to on board storage memory, but can also be configured for wireless data transfer to an external device or source.

According to an aspect of the present disclosure, the disclosed thin film camera device can operate on and store data independently, or can be coupled to a data storage device either through a special wire connection using a connection technology (e.g. USB, IEEE 394 FireWire) or wireless network connection using a wireless technology (e.g. Bluetooth, WiFi).

According to an aspect of the present disclosure, the connection technology used for the disclosed thin film camera device includes all versions of USB (USB 2.0, 3.0), IEEE 394 FireWire, the latest wired connection technology and other similar wire connection standards.

According to an aspect of the present disclosure, the wireless technology used for the disclosed thin film camera device includes Bluetooth, WiFi, 802.11g, 4G, 5G, the latest wireless standards, and other similar wireless standards.

According to an aspect of the present disclosure, the disclosed thin film camera device is not limited to using the wireless technology of Bluetooth, WiFi, 802.11g, 4G, 5G, the latest wireless standards and other similar wireless standards and/or the connection technology of all versions of USB (USB 2.0, 3.0), IEEE 394 FireWire, the latest wired connection technology and other similar wire connection standards.

According to an aspect of the present disclosure, the disclosed thin film camera device can house wireless circuitry for data connectivity, such as a wireless connectivity component having circuitry to connect the disclosed thin film camera device with at least one external device using a wireless technology as described above.

According to an aspect of the present disclosure, the disclosed thin film camera device can use at least one port, the at least one port using a connection technology as described above to connect to at least one external device via a cable, wire or other physical connection.

According to an aspect of the present disclosure, the disclosed thin film camera device is not limited to a square or rectangle shape but can be circular, hexagonal, triangular, trapezoidal, shaped in the figure of a character, logo, symbol or icon, or formed into any shape.

According to an aspect of the present disclosure, the disclosed thin film camera device is not limited to the size shown and can be very large, as large as a sheet of paper, or poster, or wall, or small as a post-it pad, or smaller than a coin such as a nickel, penny or dime. The disclosed thin film camera device covers an entire range of sizes.

According to an aspect of the present disclosure, the disclosed thin film camera device can perform both lens using lens-based technology and non-lens image capture using non-lens based technology.

According to an aspect of the present disclosure, image and video can be captured by the disclosed thin film camera device at night, in the dark, or in extreme light situations (such as very bright conditions), or extreme weather conditions (such as a very hot or a very cold environment).

According to an aspect of the present disclosure, a button function on the actual disclosed thin film camera device itself may allow the disclosed thin film camera device to take photos or video without being connected to a smartphone or a remote which when a button is pressed on such a device, allows the user to take video or photos with the thin film camera device. Furthermore, the videos and photos may be stored on on-board storage or also may be stored in external devices (e.g. smartphone, smart tablet, computer) that may be connected wirelessly to the disclosed thin film camera device. In one aspect, this storage feature using the button on the disclosed thin film camera device is limited to streaming data to another device (TV, camera) or over a network, e.g. data streaming over a network to another network, a device, or a network of device(s).

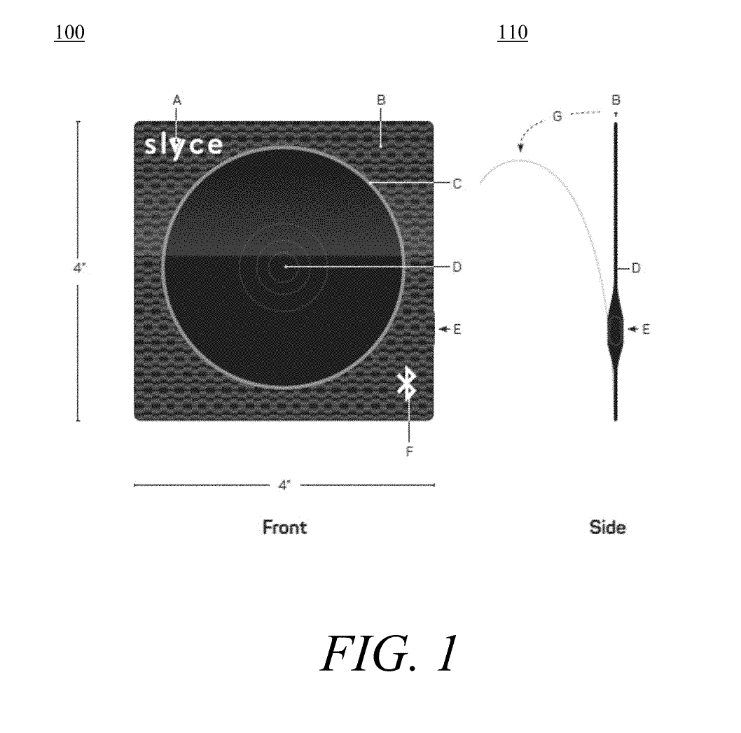

FIG. 1 shows a front view 100 and a side view 100 of a thin film camera device according to aspects of the disclosure. In front view 100, a logo “A” can be placed. A flexible camera base or flexible base “B” also mounts all the camera features. The flexible base “B” can be made of carbon fiber, for example. The flexible base “B” is also as thin as possible, yet strong enough to hold all the components necessary for a camera. The film on the back of the flexible base “B” can peel away to expose an adhesive layer for sticking onto different surfaces via the adhesive layer. Camera color “C” may be a light gray accent color. The camera color “C” may also light up with indicator colors to represent states such as charging, pairing, being turned on, and so on and so forth. Pairing may also occur with any new and readily available pairing technology currently available. For example, and just as a non-limiting example, Bluetooth can be used (as shown by the Bluetooth icon) as a pairing technology to connect the thin film camera device with other devices such as smart phones, smart tablets, computers, remotes and other similar devices. The disclosed thin film camera also may utilize WiFi communication methods to connect to a network but, the connection is not limited to only WiFi but may be whatever the latest best practices are for connectivity, e.g. Bluetooth, WiFi, 802.11g, 4G, 5G, the latest wireless standards, and other similar wireless standards e.g., whatever may be the latest wireless connectivity standard to use for wireless network connections. The lens “D” functions as a normal camera lens in a camera. The lens “D” is also manufactured as thin as possible in order to hold all the different components within the camera shown in front view 100 and operate effectively as a camera. The lens also enable image and video capture using lenses or non-lenses. The zoom, focus and other camera features may also be controlled by an auxiliary device such as a remote, or a smart phone powered through a software application (not shown). The lens “D” can also utilize lens or non-lens based technology to capture images or video. For example, the lens “D” can use spiral-etched gratings, sensors, apertures and similar structures that allow for the capture of light, images and video data without the use of any lenses. Port “E” can be a mini-USB port or another configured port for input, charging or connecting to other interfaces such as other screens. Port “E” may also be a “wired” port capability for data transfer, data output and power transfer and generation using a wired connection technology that is not limited to a current term or technology, e.g. all versions of USB (USB 2.0, 3.0), IEEE 394 FireWire, the latest wired connection technology and other similar wire connection standards. Standard logo “F” may be a logo for a technology used by the thin film camera device, such as Bluetooth. Motion “G” shows that the film on the back of the flexible camera base “B” can be peeled away to expose an adhesive for sticking on different surfaces.

Furthermore, a mounting hole can be formed (by the user or a manufacture) anywhere in the flexible base “B” as long as circuitry in the lens (such as from a capturing component that contains circuitry to take pictures or record video; or a wireless connectivity component that contains circuitry to wirelessly couple the thin film camera to at least one external device; or on-board storage memory circuitry) is not damaged, displaced or interfered with.

The front side of the flexible base “B” can also absorb light or solar capabilities for power generation and sustainment in addition to serving as an internal power source for the thin film camera.

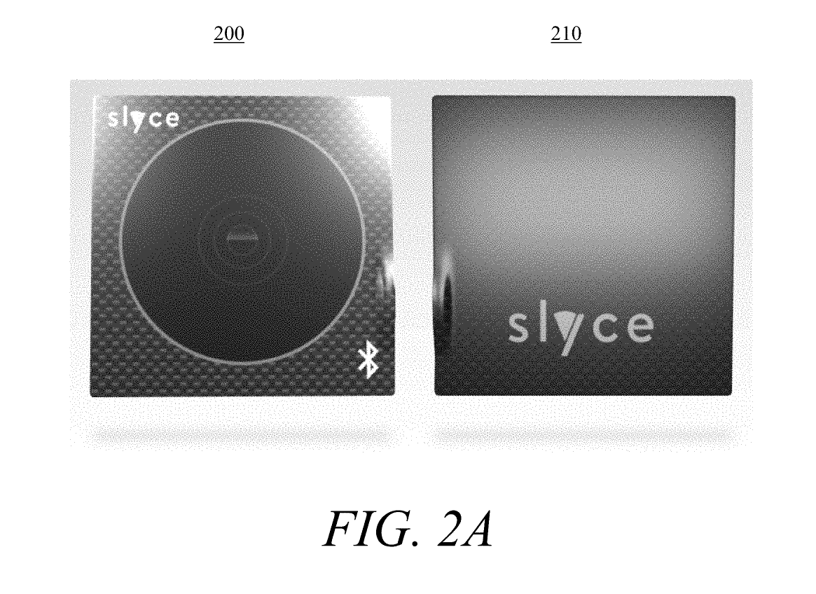

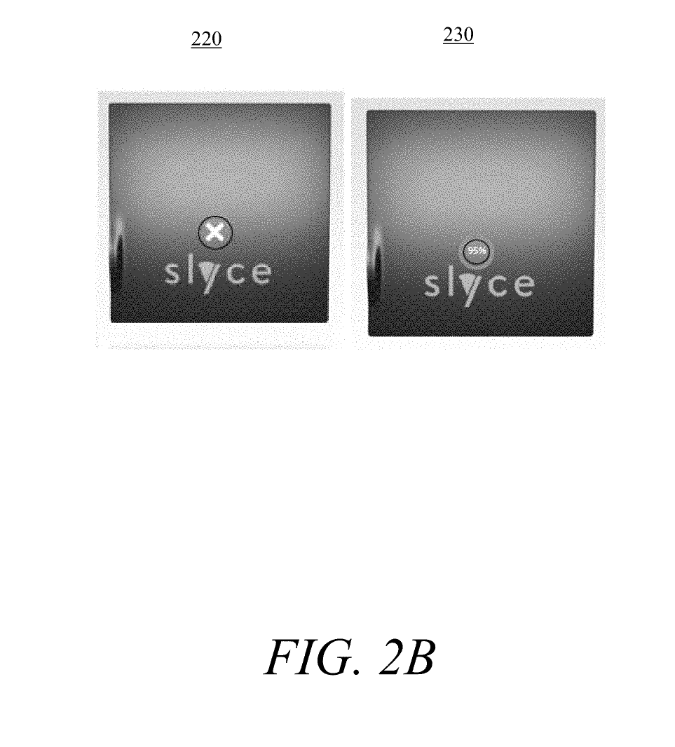

FIG. 2A shows another front view 200 and rear view 210 of the thin film camera device, according to aspects of the disclosure. The relative simplicity of the features can also be seen from these two views as well.

FIG. 2B shows a first rear view 220 and a second rear view 230 of the thin film camera device, according to aspects of the disclosure.

In first rear view 220, a touch sensitive button is a paper-thin button shown by the (X) icon. The touch sensitive button can be tapped in order to take an image with the thin film camera device. The touch sensitive button can be held down in order to record video with the thin film camera device. The touch sensitive button will allow the thin film camera device to store data on board. Also, pressing the button in another aspect of the present disclosure will allow the thin film camera device to transfer data to a remote/smartphone/network or other at least one eternal device. The touch sensitive button has also been placed as shown to strategically ensure aesthetics and ergonomics make sense to hand/thumb (of the left or right hand).

In second rear view 230, a circular progress bar is shown (the circle with the 95%) and a button within that circle, the circular progress bar notifying the status of space on the thin film camera device to store content. Tapping the button within the circular progress bar can also trigger the thin film camera device to take a picture, which may also result in a flash (or blinking effect) showing the progress bar as complete with the circular motion connected as a full circle. Holding down the button within the circular progress bar will move the progress bar closer to 100 percent indicating that the maximum allotment has been used for the clip or video.

Two percentages may also be shown. For an image snapshot, a user taps and holds, lets go, progress bar is a full circle and connected it blinks for less that 2 seconds and disappears. What remains is the total % of space on device in middle of button.

For full/segmental video, the user taps and holds the button. The % increases the closer to storage allotment. Once the button is let go, the remaining % of total space on device is displayed on the middle of button.

In one aspect of the present disclosure, double tapping the button will erase the data on the device, which makes an X appear. When the X is pushed, all stored content can be deleted or erased.

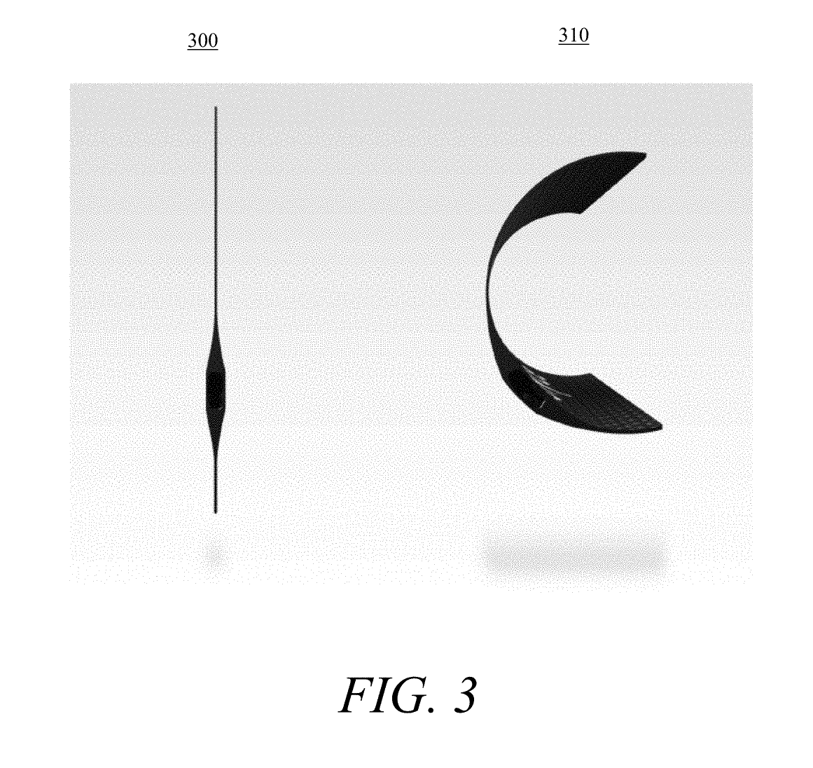

FIG. 3 shows a first side view 300 and a second side view 310 of the thin film camera device, according to aspects of the disclosure. First side view 300 shows the thin film camera device not being bent or flexed and in a straight, default position. Second side view 310 shows the thin film camera device being slightly bent or flexed, thereby showcasing the flexibility of the camera.

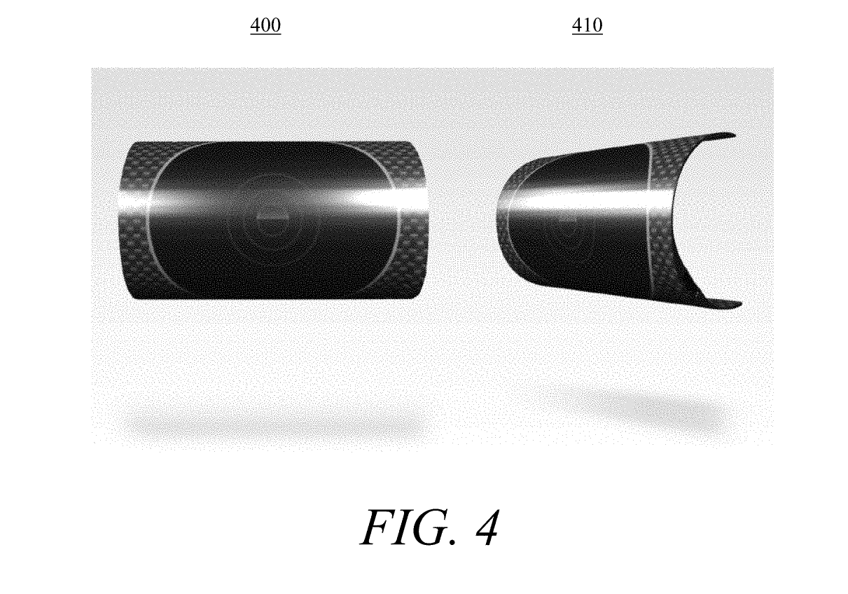

FIG. 4 shows a front view 400 and a perspective view 410 of the thin film camera device, according to aspects of the disclosure. The front view 400 shows a front view of the thin film camera device being bent or flexed. The perspective view 410 may be taken at a ¾ or 45 degree angle and also shows the thin film camera device being bent or flexed.

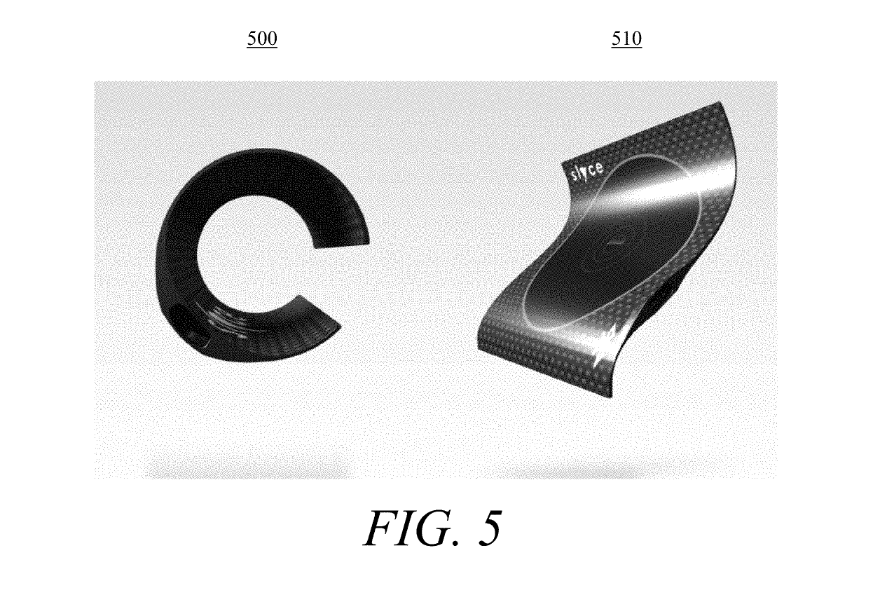

FIG. 5 shows a side view 500 and a perspective view 510 of the thin film camera device, according to aspects of the disclosure. The side view 500 shows a side view of the thin film camera being bent or flexed in an extreme manner, showcasing the extreme flexibility of the thin film camera device. The perspective view 510 may be taken at a ¼ or 22.5 degree angle, or a ¾ or 45 degree angle, and also shows the extreme flexibility of the thin camera device when it is bent, flexed or warped in an extreme manner.

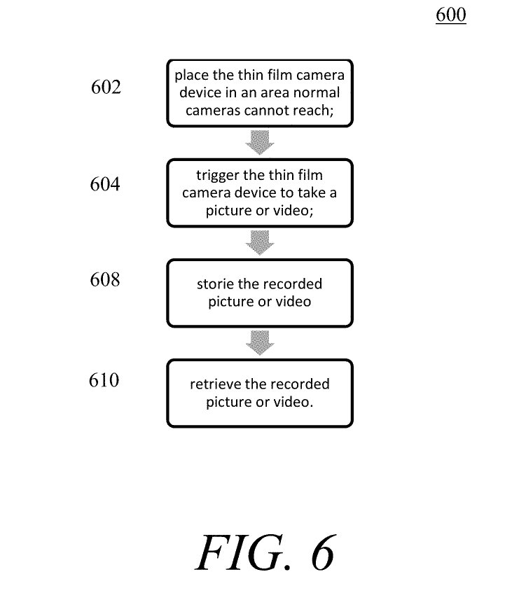

FIG. 6 shows a method 00 with the following steps: (step 602) placing the thin film camera device in an area normal cameras cannot reach; (step 604) triggering the thin film camera device to take a picture or video; (step 606) storing the recorded picture or video; and (step 608) retrieving the recorded picture or video.

The thin film camera device may also have processors and hardware on its thin film camera base in order to assist in processing of other camera features. Software or code may be loaded onto these processors or hardware to also assist in various camera functions.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

For a firmware and/or software implementation, the methodologies may be implemented with modules (e.g., procedures, functions, and so on) that perform the functions described herein. A machine-readable medium tangibly embodying instructions may be used in implementing the methodologies described herein. For example, software codes may be stored in a memory and executed by a processor unit. Memory may be implemented within the processor unit or external to the processor unit. As used herein, the term “memory” refers to types of long term, short term, volatile, nonvolatile, or other memory and is not to be limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include RAM, ROM, EEPROM, CD-ROM or other optical disk storage, magnetic disk storage or other magnetic storage devices, or other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above and below may refer to sides of a substrate or electronic device. Moreover, the scope of the present application is not intended to be limited to the particular configurations of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

What is claimed is:

1. A thin film camera device, comprising:
a flexible base;
a capturing component comprising circuitry used to take images or video;
an on-board storage memory;
at least one port; and
a wireless connectivity component comprising circuitry for configuring a wireless connection with at least one external device.

2. The device of claim 1, wherein the capturing component comprises lens-based technology and non-lens based technology.

3. The device of claim 1, wherein the flexible base has a layer made of a film that can be peeled away to expose an adhesive layer for sticking the thin film camera device onto surfaces.

4. The device of claim 1, wherein the flexible base comprises a mounting hole that is safely apart from the capturing component, the on-board storage memory, the at least one port and the wireless connectivity component, the mounting hole allowing a mounting apparatus to go through it to mount the thin film camera device to any surface.

5. The device of claim 1, wherein the at least one external device comprises a smartphone, a smart tablet, a computer, a remote and similar devices, and further wherein the at least one external device can control the functionality of the thin film camera device.

6. The device of claim 1, wherein the wireless connectivity component uses wireless technology to connect the thin film camera device with at least one external device, the wireless technology comprising Bluetooth, WiFi, 802.11g, 4G, 5G, the latest wireless standards, and other similar wireless standards.

7. The device of claim 1, wherein at least one coupled device is coupled via a wire and the at least one port to the thin film camera device using a connection technology comprising all versions of USB (USB 2.0, 3.0), IEEE 394 FireWire, the latest wire connection technology and other similar wire connection standards, the at least one coupled device comprising a smartphone, a smart tablet, a computer, a remote and similar devices, and further wherein the at least one external device can control the functionality of the thin film camera device.

8. The device of claim 1, further comprising at least one on-board button, which when pressed, controls functionality of the thin film camera device.

9. A method for using a thin film camera device, comprising:
placing the thin film camera device in an area normal cameras cannot reach;
triggering the thin film camera device to take a picture or video;
storing the recorded picture or video; and
retrieving the recorded picture or video.

10. The method of claim 9, wherein the thin film camera device comprises a flexible base and further wherein placing the thin film camera device in an area normal cameras cannot reach includes:
peeling away a film from a layer of a flexible base of the thin film camera device to reveal an adhesive layer; and
adhering the thin film camera device on a surface with the adhesive layer.

11. The method of claim 9, wherein the thin film camera device comprises a flexible base including a mounting hole, and further wherein placing the thin film camera device in an area normal cameras cannot reach includes:
fitting a mounting apparatus through the mounting hole; and
securely mounting the thin film camera device to a surface with the mounting apparatus fitted into the mounting hole.

12. The method of claim 9, wherein the thin film camera device comprises a wireless connectivity component that enables the thin film camera device to connect to at least one external device comprising a smartphone, a smart tablet, a computer, a remote and similar devices via a wireless technology, and further wherein triggering the thin film camera device to take a picture or video comprises:
using functionality on the at least one external device to send a signal to the thin film camera device, the signal comprising an action to take a picture and to record video;
enabling the thin film camera device receive that signal; and
executing the action with the thin film camera based on the received signal.

13. The method of claim 12, wherein the wireless technology comprises Bluetooth, WiFi, 802.11g, 4G, 5G, the latest wireless standards, and other similar wireless standards.

14. The method of claim 9, wherein the thin film camera device comprises a at least one port that enables the thin film camera device to connect to at least one external device comprising a smartphone, a smart tablet, a computer, a remote and similar devices via a connection technology, and further wherein triggering the thin film camera device to take a picture or video comprises:
using functionality on the at least one external device to send a signal to the thin film camera device via the connection technology, the signal comprising an action to take a picture and to record video;
enabling the thin film camera device receive that signal; and
executing the action with the thin film camera based on the received signal.

15. The method of claim 14, wherein the connection technology comprises all versions of USB (USB 2.0, 3.0), IEEE 394 FireWire, the latest wired connection technology and other similar wire connection standards.

16. The method of claim 9, wherein the thin film camera device comprises at least one button, and further wherein triggering the thin film camera device to take a picture or video comprises:
pressing the at least one button to send a signal to the thin film camera device, the signal comprising an action to take a picture and to record video;
enabling the thin film camera device receive that signal; and
executing the action with the thin film camera based on the received signal.

17. The method of claim 16, wherein pressing the at least one button to send a signal to the thin film camera device comprises:
pressing the at least one button to send a signal to take a picture as the signal; and
holding down the at least one button to send a signal to record video as the signal.

18. The method of claim 9, wherein the thin film camera device comprises an on-board storage memory and further wherein storing the recorded picture or video comprises storing the recorded picture or video in the on-board storage memory.

19. The method of claim 12, wherein retrieving the recorded picture or video comprises:
sending the recorded picture or video to the at least one external device via the wireless technology; and
receiving the recorded picture or video by the at least one external device.

20. The method of claim 14, wherein retrieving the recorded picture or video comprises:
sending the recorded picture or video to the at least one external device via the connection technology; and
receiving the recorded picture or video by the at least one external device.
